(19) United States
(12) Patent Application Publication
(10) Pub. No.: US 2026/0278818 A1
(43) Pub. Date: Sep. 17, 2026

(54) METHOD FOR MODELLING AN ANATOMICAL STRUCTURE OF THE HUMAN BODY

(71) Applicants: UNIVERSITÉ BREST BRETAGNE OCCIDENTALE, Brest (FR); INSTITUT NATIONAL DE LA SANTÉ ET DE LA RECHERCHE MÉDICALE, Paris (FR)

(72) Inventors: Gwenolé QUELLEC, Brest (FR); Mathieu LAMARD, GUILERS (FR); Ikram BRAHIM, Brest (FR)

(73) Assignees: UNIVERSITÉ BREST BRETAGNE OCCIDENTALE, Brest (FR); INSTITUT NATIONAL DE LA SANTÉ ET DE LA RECHERCHE MÉDICALE, Paris (FR)

(21) Appl. No.: 18/871,953

(22) PCT Filed: Jun. 8, 2023
(86) PCT No.: PCT/EP2023/065419

§ 371 Date: Dec. 5, 2024

(30) Foreign Application Priority Data
Jun. 8, 2022 (EP) 22305830.6

(51) Int. Cl. G06T 7/579; G06T 17/00

(52) U.S. Cl. CPC G06T 7/579; G06T 17/00; G06T 2207/20081; G06T 2207/30041

(57) ABSTRACT

A method for modeling an anatomical structure of the human body in three dimensions that is computer-implemented and that includes the following steps: obtaining a plurality of consecutive images of the anatomical structure using a device for capturing images that is in movement and that bears a light source, identifying anatomical sub-structures of the anatomical structure in the obtained images, carrying out three-dimensional modeling of the anatomical structure based on the obtained images, and comparing the three-dimensional shape of the anatomical sub-structures of the obtained images with models of anatomical sub-structures stored in a database, wherein the step carrying out three-dimensional modeling of the anatomical structure is based on the obtained images comprising predicting the depth of the anatomical structure and predicting the movement of the image-capturing device.

### FIELD

The invention relates to methods and devices for imaging anatomical structures of the human body, and more particularly to methods and devices enabling three-dimensional modeling of such structures.

### BACKGROUND

The production of three-dimensional models of anatomical structures for the diagnosis of various pathologies is increasingly being carried out in order to be able to diagnose these pathologies with precision. Hereinafter, we will consider the example of the diagnosis of dry eyes, which can be caused by smoking, contact lens wear, Parkinson's disease, lupus or rheumatoid arthritis, inter alia.

Physicians have poor precision and reproducibility in quantifying dry eye, which complicates treatment evaluation and prescription. To quantify dry eye, a slit lamp may be used. For example, the ophthalmologist may first apply a contrast medium to the cornea, and then observe a plurality of signs of dryness. Firstly, he measures the time it takes for the tear film to tear after a blink, a short time indicating a thin film. Next, he detects areas of the ocular surface damaged by dryness. These areas take the form of dots, spots or filaments: depending on their number and location, a degree of dry eye can be determined. Dyes can also be used to highlight ocular lesions of the sclera and cornea. The problem with these measurements is that they are not very precise or reproducible. These limitations prevent reliable quantification of how dry eye evolves in a patient. In particular, they do not allow the effect of a treatment to be measured satisfactorily.

There are also other diagnostic methods that dispense with slit-lamp examination to diagnose dry eye: dedicated apparatuses based on different imaging principles, such as meibography, are being developed. The slit lamp, with which every ophthalmologist is equipped, must then be replaced by a new apparatus.

In all cases (for an ocular examination or any other type of examination), a video is acquired (by slit lamp, endoscope or surgical microscope). Egomotion principles (linked to the three-dimensional movement of a camera in relation to its environment) are used to create three-dimensional models from videos acquired by an imaging apparatus such as those mentioned above. However, the problem with these methods is that they violate a founding principle of Structure from Motion techniques, namely that two corresponding structures in two consecutive frames of a video will have the same color and intensity. However, in the aforementioned images, the lighting is linked to the camera, not to the scene, which invalidates the hypothesis (the results of the above methods are highly dependent on the light and shadows of the scene being analyzed). In addition, modeling errors can occur depending on the modeling case.

### SUMMARY

In particular, the aim of the invention is to provide a method for modeling an anatomical structure of the human body, enabling more reliable and repeatable three-dimensional modeling than solutions proposed in the prior art.

To this end, the invention relates to a method for modeling an anatomical structure of the human body in three dimensions that is computer-implemented and that comprises the following steps:
Obtaining a plurality of consecutive images of the anatomical structure using a device for capturing images that is in movement and that bears a light source, the light source being configured to illuminate the anatomical structure,
Identifying anatomical sub-structures of the anatomical structure in the obtained images,
Carrying out three-dimensional modeling of the anatomical structure based on the obtained images,
Comparing the three-dimensional shape of the anatomical sub-structures of the obtained images with models of anatomical sub-structures stored in a database,
   the step of carrying out three-dimensional modeling of the anatomical structure based on the obtained images comprising predicting the depth of the anatomical structure and predicting the movement of the image-capturing device.

The result is a three-dimensional “Structure from Motion” modeling method for modeling anatomical structures of the human body, first comprising a step for semantic segmentation of the captured images into sub-structures of interest, with verification of the consistency of these sub-structures with sub-structures in a database which represent, in terms of shape, the type of sub-structures to be observed. This allows any modeling errors to be corrected by comparison with known, proven structures. These so-called “3-D shape matching” techniques enable reliable, repeatable modeling.

In short, prior knowledge of the sub-structures to be observed in a structure of interest and an assumption derived from the fact that the light source is carried by the image-capturing device are used to reliably and repeatably model an anatomical structure in three dimensions. The result is an image with excellent resolution, wide field of view and no illumination artifacts.

According to other optional features of the modeling method, taken either alone or in combination:
the step of obtaining a plurality of consecutive images of the anatomical structure comprises recording a video followed by cutting this video into a plurality of consecutive images;
the modeling method is a self-supervised method;
the modeling method comprises a step of feeding an artificial intelligence with sub-structure models stored in a database;
modeling is performed in real time;
the step of performing a three-dimensional modeling of the anatomical structure from the images is a modeling of the identified anatomical sub-structures; the step of comparing the three-dimensional shape of the anatomical sub-structures of the obtained images with anatomical sub-structure models stored in a database comprises the use of the following loss functions: semantic reconstruction loss, sphere fitting loss, shape retention loss, and preferably photometric loss, structure similarity loss as well as depth smoothing;
the modeling method is a three-dimensional eye modeling method; and
the anatomical sub-structures are the cornea and the sclera.

The invention also relates to a computer program comprising instructions which, when the program is executed by a computer, cause the latter to implement the steps of the method according to the invention.

The invention also relates to a computer-readable recording medium comprising instructions which, when executed by a computer, cause the latter to implement the steps of the method according to the invention.

The invention also relates to a method for detecting a pathology resulting from the observation of a structure of the human body comprising:
A modeling method according to the invention, and
A pathology diagnosis step based on the modeling performed.

The invention also relates to a device for modeling an anatomical structure of the human body in three dimensions for implementing a method according to the invention and comprising:
a moving image-capturing device carrying a light source,
means for producing a three-dimensional model of the anatomical structure from the images obtained,
means for identifying anatomical sub-structures of the anatomical structure in the images obtained, and
means for comparing the three-dimensional shape of the anatomical sub-structures of the obtained images with the models of sub-structures stored in a database.

Preferably, the image-capturing device is formed by a camera configured to record video.

### BRIEF DESCRIPTION OF THE FIGURES

The invention will be better understood on reading the following description given solely by way of example and with reference to the appended drawings in which:

FIG. 1 is a schematic representation of the method according to the invention, and

FIG. 2 is a representation of a model according to the invention.

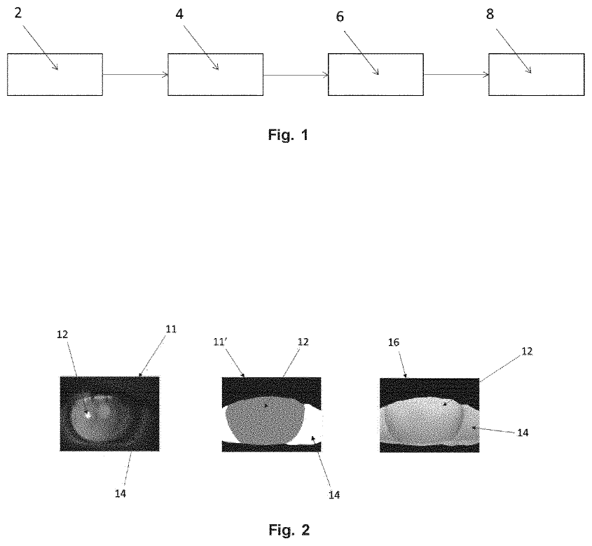

### DETAILED DESCRIPTION

We will now describe a step-by-step modeling method according to the invention. In the following description, a three-dimensional model of an eye will serve as an example to exemplify the various steps. As explained above, the modeling method and device can also be used to model other anatomical structures in the human body. In this section, we also describe a self-supervised method, which is advantageous in our case. A self-supervised method is a machine-learning method based on a neural network designed to ingest unlabeled data.

The method disclosed here is preferably carried out in real time.

The first step 2 consists in obtaining a plurality of consecutive images of the anatomical structure using a device for capturing images that is in movement and carrying a light source configured to illuminate the anatomical structure. The image-capturing device can be carried by a slit lamp, an endoscope, etc. The light source can be of any known type that illuminates the anatomical structures to be modeled. These known means will not be detailed in this application. Camera movement implies the implementation of a “Structure from Motion” method, as explained above.

The image-capturing device may be a video camera. It could also be an apparatus that takes snapshots alternately with video. In the case of eye examinations, for example, videos can be recorded using a Haag Streit BQ 900 slit lamp and the CM 900 camera module (resolution 1600×1200, 12 frames per second). The magnification can be set to ×10 and the ocular surface analyzed after illumination with white light, followed by cobalt blue light and the interposition of a yellow filter.

In the case of a video, the video is cut into a plurality of frames. For example, these may be sequences of three images with an interval of ten images between each sequence (this may be the case, for example, with a 12 fps camera).

The selected images are then processed to predict the semantic segmentation of each of them (step 4). To achieve this, a segmentation network based on a Feature Pyramid Network model can be used to predict this semantic segmentation of the anatomical structure to be modeled into sub-structures of interest, by labeling pixels belonging to one anatomical sub-structure or another. In the case of the eye, for example, these can be the cornea and the sclera. Other structures may be deliberately omitted as a source of modeling problems. To do this, each pixel can be classified into the following classes: eyelid, sclera, cornea. All pixels labeled “eyelid” are ignored in learning and inference, as they contain no useful information for modeling (the eyelid also moves relative to the eyeball, which goes against the assumption underlying the model described and cannot be modeled by a rigid (spherical) shape model).

In the next step 6, the images are used to create a three-dimensional model of the anatomical structure. This prediction can be achieved using two convolutional neural networks (in the case of a self-supervised method) which can be used to predict depth (DepthNet convolutional neural network) and the movement of the image-capturing device, or egomotion (EgomotionNet convolutional neural network). The DepthNet and EgomotionNet architectures used are those proposed in the paper “Casser, V., Pirk, S., Mahjourian, R., & Angelova, A. (2019). Unsupervised monocular depth and ego-motion learning with structure and semantics. In Proceedings of the IEEE/CVF Conference on Computer Vision and Pattern Recognition Workshops (pp. 0-0)”.

The DepthNet convolutional neural network uses a fully convolutional encoder-decoder architecture to obtain a dense depth map from a single Red-Green-Blue image. It can be represented by the following equation:

$${D}_{i} = θ ( {I}_{i} ) , θ : {ℝ}^{( H \times W \times 3 )} \to {ℝ}^{H \times 3 W )} .$$

where Iᵢ is the image at time i, Dᵢ is the depth map associated with the image, H is the image height, and W is the image width.

The EgomotionNet convolutional neural network, for example, takes three consecutive images and predicts transformations simultaneously. Both neural networks are used for inference and training artificial intelligence in a self-supervised method. This modeling enables us to visualize any damaged areas on the surface of the eye. It can be represented by the following equations:

$${ψ}_{E} ( {I}_{i - n} , {I}_{i} ) = ( {t}_{{x}_{1}} , {t}_{{y}_{1}} , {t}_{{z}_{1}} , {r}_{{x}_{1}} , {r}_{{y}_{1}} , {r}_{{z}_{1}} ) , and$$

$${ψ}_{E} ( {I}_{i} , {I}_{i + n} ) = ( {t}_{{x}_{2}} , {t}_{{y}_{2}} , {t}_{{z}_{2}} , {r}_{{x}_{2}} , {r}_{{y}_{2}} , {r}_{{z}_{2}} ) ,$$

where Iᵢ is the image at time i, Iᵢ₊ₙ is the image at time i+n, t is translation in the x, y, z directions, and r is rotation in the x, y, z directions.

A plurality of loss functions are taken into account for accurate, reproducible three-dimensional modeling. These enable step 8 to compare the three-dimensional shape of the anatomical sub-structures of the obtained images with models of sub-structures stored in a database.

The first and most important of these is semantic reconstruction loss (SRL), which is the main supervisory signal. It can be represented by the following equation:

$${ℒ}_{SRL} = min ( ‖ {\hat{S}}_{i \to j} - {S}_{j} ‖ )$$

where Sⱼ is the segmentation of image j, and Si→j is the segmentation of image i recalibrated to the segmentation of image j.

The second, photometric loss (recon) is similar to semantic reconstruction loss, except that the images are used as an entry point for comparing one reconstructed image with the next. It can be represented by the following equation:

$${ℒ}_{recon} = min ( ‖ {\hat{I}}_{i \to j} - {I}_{j} ‖ ) ,$$

where Iⱼ is image j, and I_{i→j} is image i recalibrated to image j.

The third is structural similarity loss (SSIM), used to compare luminance, contrast and structure between one reconstructed image and the next. It can be represented by the following equations:

$${ℒ}_{SSIM} = 1 - SSIM ( i , j ) ,$$

$$SSIM ( i , j ) = \frac{( 2 {μ}_{i} {μ}_{j} + {l}_{1} ) ( 2 {σ}_{ij} + {l}_{2} )}{( {μ}_{i}^{2} + {μ}_{j}^{2} + {l}_{1} ) ( {σ}_{i}^{2} + {σ}_{j}^{2} + {l}_{2} )}$$

where μᵢ, μⱼ are the mean, σ²ᵢ, σ²ⱼ the variance, and σᵢⱼ the covariance of x,y, L is the dynamic range of pixel values, k₁=0.01, and k₂=0.03.

The fourth is depth smoothness (DS), which encourages smoothing by penalizing depth discontinuity if the image shows continuity in the same area.

It can be represented by the following equations:

$${ℒ}_{DS} = \vert {∇}_{x} {D}_{i} \vert {e}^{- {∇}_{x} {I}_{i}} \vert + \vert {∇}_{y} {D}_{i} \vert {e}^{- {∇}_{y} {I}_{i}} \vert ,$$

where Iᵢ is the image i, Dᵢ is the depth map associated with image Iᵢ, ∇x,∇y are the gradients of image Iᵢ in the horizontal and vertical directions.

One of the main ones, forming in particular the step of comparing the three-dimensional shape of the anatomical sub-structures of the images obtained with sub-structure models stored in a database, is sphere fitting loss. In the case of an eye examination, the latter is used for what is thought to be the shape of the eye: two intersecting spheres. A smaller anterior sphere represents the cornea and a posterior sphere the sclera. In order to implement this loss, we first estimate a depth mapping, then using semantic segmentation it is possible the sphericity the two regions: cornea and sclera. Alternatively, a threshold can be applied to the surface before calculating this loss, to ensure that both anatomical sub-structures are present. Once an image matches the threshold, it is possible to use the depth estimates for the cornea or sclera to convert this into a three-dimensional point cloud projection using the inverse of the intrinsic matrix. It is then possible to use an estimated point cloud and apply a least-squares sphere fit. It is then possible to determine the best sphere center for the given data points.

By rearranging the terms in the following equation:

$${( x - {x}_{0} )}^{2} + {( y - {y}_{0} )}^{2} + {( z - {z}_{0} )}^{2} = {r}^{2} ,$$

where x,y,z are points in space, x₀, y₀, z₀ are the coordinates of the center of the sphere, and r is the radius of the sphere,
it is possible to express the equation in matrix notation and solve the following equation for the term \vec{C}:

$$\vec{f} = A \vec{e}$$

Where:

$$\vec{f} = [ \begin{matrix}{x}_{k}^{2} + {y}_{k}^{2} + {z}_{k}^{2} \\ {x}_{k + 1}^{2} + {y}_{k + 1}^{2} + {z}_{k + 1}^{2} \\ ⋮ \\ {x}_{n}^{2} + {y}_{n}^{2} + {z}_{n}^{2}\end{matrix} ]$$

$$A = [ \begin{matrix}2 {x}_{k} & 2 {y}_{k} & 2 {z}_{k} & 1 \\ 2 {x}_{k + 1} & 2 {y}_{k + 1} & 2 {z}_{k + 1} & 1 \\ ⋮ & ⋮ & ⋮ & ⋮ \\ 2 {x}_{n} & 2 {y}_{n} & 2 {z}_{n} & 1\end{matrix} ]$$

$$\vec{c} = [ \begin{matrix}{x}_{0} \\ {y}_{0} \\ {z}_{0} \\ {r}^{2} - {x}_{0}^{2} - {y}_{0}^{2} - {z}_{0}^{2}\end{matrix} ]$$

where xₖ,yₖ,zₖ is one of the data points, x₀, y₀, z₀ are the coordinates of the center of the sphere, r is the radius of the sphere.

By fitting the n data points xₖ, yₖ, zₖ, it is possible to solve for the coordinates of the sphere center x₀, y₀, z₀ and the radius r.

The sphere fitting loss is the mean square error between the fitted sphere and the data points. Sphericity for each of the corneal and scleral regions have a weighting aₑ. With both regions fitted to a sphere, it is then possible to calculate the loss for each pixel p. The corresponding equations are as follows:

$${ℒ}_{SFL} = {ℒ}_{{cornea}_{SFL}} + {ℒ}_{{sclera}_{SFL}}$$

$${ℒ}_{{cornea}_{SFL}} = \frac{1}{{p}_{c}} {\sum }_{k = 1}^{{p}_{c}} {( ( {x}_{ck} - {x}_{c 0} ) - {r}_{c} )}^{2} ,$$

$${ℒ}_{{sclera}_{SFL}} = \frac{1}{{p}_{s}} {\sum }_{k = 1}^{{p}_{s}} {( ( {x}_{sk} - {x}_{s 0} ) - {r}_{s} )}^{2}$$

where pc is the number of pixels on the corneal surface and ps the number of pixels on the scleral surface, xck the corneal data points, xc0 the coordinates of the center of the cornea, xsk the scleral data points, xs0 the coordinates of the center of the scleral sphere.

The above set of loss functions are used to obtain a model using a differentiable image deformation operator taking into account a Red-Green-Blue image Îᵢ, a depth mapping Dⱼ, and an egomotion Ei→j, resulting in a reconstructed image Îjth. This is modeled by the following equation:

$${ℒ}_{total} = {α}_{a} {ℒ}_{SRL} + {α}_{b} {ℒ}_{recon} + {α}_{c} {ℒ}_{SSIM} + {α}_{d} {ℒ}_{DS} + {α}_{e} {ℒ}_{SFL}$$

A fifth is structural similarity loss (SSIM), L_{SCL} implemented to take into account the temporal context of the videos, that is, to track and ensure that intrinsic scene attributes remain unchanged over time. In the case of eye examinations, it models the fact that the shape of a patient's ocular surface, and in particular the radius of the two spheres, remains unchanged during an examination. The aim is to make shape predictions more robust, less sensitive to variations in illumination, eyelid opening and so on. In this case, N images are randomly selected from the same video, at instants i₁, i₂, . . . i_{N}. Then we consider the predicted radius for the cornea and sclera, for each of these images: r_{c1}, r_{c2}, . . . r_{cN} and rₛ₁, rₛ₂, . . . r_{sN}, respectively. The aim is to minimize the standard deviation of sphere radius predictions within each of the two sets. The corresponding equations are as follows:

$${ℒ}_{SCL} = {ℒ}_{corneaSCL} + {ℒ}_{scleraSCL}$$

$${ℒ}_{corneaSCL} = \sqrt{\frac{1}{N} {\sum }_{i = 1}^{N} {( {r}_{xi} - \frac{1}{N} {\sum }_{i = 1}^{N} {r}_{ck} )}^{2}}$$

$${ℒ}_{scleraSCL} = \sqrt{\frac{1}{N} {\sum }_{j = 1}^{N} {( {r}_{xj} - \frac{1}{N} {\sum }_{i = 1}^{N} {r}_{sk} )}^{2}}$$

Taking into account the shape conservation loss function summed with all the other loss functions then used in the above equation, the equation is modeled as follows:

$${ℒ}_{total} = {α}_{a} {ℒ}_{SRL} + {α}_{b} {ℒ}_{recon} + {α}_{c} {ℒ}_{SSIM} + {α}_{d} {ℒ}_{DS} + {α}_{e} {ℒ}_{SFL} + {α}_{f} {ℒ}_{SCL}$$

The above-mentioned database can be included in local or remote storage facilities. The aim of the step of comparing the three-dimensional shape of the anatomical sub-structures of the images obtained with sub-structure models stored in a database is to check that the three-dimensional modeling performed above conforms, in terms of the general shapes of the sub-structures of interest, to a physical reality corresponding to the models stored in the database. In the case of a self-supervised method, it is a matter of feeding an artificial intelligence with known and robust data with training.

### EXEMPLARY EMBODIMENTS

After image capture and semantic segmentation using the devices (video camera) and networks (“Feature Pyramid Network”) disclosed herein before, the data is processed using the convolutional neural networks disclosed above and various loss functions to produce a three-dimensional model, in this case of a human eye.

The first step in this example was to manually annotate points corresponding to damaged areas on the surface of the eye, and visible veins in the sclera. To visualize the accuracy of the predictions made (semantic segmentation, depth, egomotion), a source image was transformed into a target image and the points marked were tracked. Using the equation

$${p}_{s} ∼ K {\hat{T}}_{t \to s} {\hat{D}}_{t} ( {p}_{t} ) {K}^{- 1} {p}_{t} ,$$

where pₛ is the source image pixels, pₜ is the target image pixels, Dt is the target image depth map, T^{t→s} is the transformation matrix, K is the intrinsic matrix, and K⁻¹ is the inverse of the intrinsic matrix.

The pixels pₛ of the source frame are projected onto the target frame pₜ. The evaluation performed used inverse deformation, which first requires the prediction of the depth map Dₜ of the target image, and then the egomotion from source to target, which also gives the transformation matrix T_{t→s}. The evaluation metric was implemented on a test set of 3 patients with 54 images. The test set consists of 126 points on the sclera on intersections of veins and punctuation marks, 33 points on the cornea of visible punctuation marks.

The baseline (or reference method according to the prior art) used for the comparison had to be trained at intervals due to the divergent loss to infinity, as well as the irreversibility of the predicted egomotion matrix.

The baseline was trained using a learning rate of 0.0002, a batch size of 8, an SSIM weighting of 0.15, an L1 reconstruction weighting of 0.85, and a depth smoothing of 0.04. The training configuration according to the invention uses a learning rate of 0.0002, a batch size of 8, an SSIM weight of 0.15, an L1 reconstruction weight of 0.15, an L2 semantic reconstruction weight of 0.04, a sphere adjustment weight 10000 and a depth smoothing weight of 0.04 [3].

All models were trained up to 200 epochs (gradient descent hyperparameter controlling the number of complete runs through the training dataset), with the best model (lowest loss achieved) retained for inference.

Table 1 below shows the results of the evaluation of our test set by different methods. By defining two of the new loss functions (sphere fitting and semantic segmentation), it is possible to stabilize the training and prevent losses from diverging. Better results are also obtained, as shown below. Despite the increase in computations during training via loss functions, inference time remains similar to that of the baseline. In the following experiments, we preprocessed the data using an n=10 frame step (including the baseline experiment).

We have compared three different configurations according to the invention:
“SiGMoid No. 3” wherein only semantic segmentation is used,
“SiGMoid No. 4” wherein semantic segmentation and sphere fitting were used, and
“SiGMoid No. 5” with another convolutional neural network used.

| | | CNN | Frame | | | Mean Euclidian | Mean |
|---|---|---|---|---|---|---|---|
| No. | Method | Inputs | step | L_{SRL} | L_{SFL} | (px) | Euclidian (%) |
| 1 | Casser [4]* | A | No | — | — | 29.08 | 1.82 |
| 2 | Casser [4]* | A | Yes | — | — | 27.19 | 1.70 |
| 3 | SiGMoid | A | Yes | Yes | No | 22.48 | 1.40 |
| 4 | SiGMoid | A | Yes | Yes | Yes | 7.7 | 0.48 |
| 5 | SiGMoid | B | Yes | Yes. | Yes | 15.16 | 0.95 |

The table above represents the results obtained using five methods: the three disclosed herein before and two prior art methods. The average Euclidean distance in pixels is lowest in SiGMoid No. 4. The method according to the invention using semantic segmentation, the convolutional neural networks disclosed herein before and the two summed loss functions achieve the lowest error with respect to the baseline. This more accurate and robust modeling means that doctors can better diagnose pathologies.

FIG. 2 shows an image 11 of a human eye, a representation of a semantic segmentation 11′ of this eye into two anatomical sub-structures, cornea 12 and sclera 14, and a model 16 of the eye using the “SiGMoid No. 4” method.

The device for modeling an anatomical structure of the human body in three dimensions comprises, as listed above:
A moving image-capturing device carrying a light source. A non-limiting example (used for the above example) has been detailed above;
Means for producing a dimensional model of the anatomical structure from the images obtained;
Means for identifying anatomical structures of the anatomical structure in the images obtained; and
Means for comparing the three-dimensional shape of the anatomical sub-structures of the obtained images with the models of sub-structures stored in a database.

The various means enabling the above modeling, identifications and comparisons can be formed by an electronic control unit comprising a non-volatile memory storing the various predetermined control programs and potentially the database comprising robust models. These means include, inter alia, conventional computing means, such as processors, random access memory and hard memory. These means execute computer program instructions, that is, executable code, recorded on computer-readable media.

The invention is not limited to the embodiments presented, and other embodiments will become clearly apparent to the person skilled in the art. As explained above, the modeling method can be implemented to model anatomical structures other than the eye. In addition, the technical means disclosed for capturing images or processing information may differ from those disclosed.

### LIST OF REFERENCES

2: step of obtaining a plurality of consecutive images of the anatomical structure using a device for capturing images that is in movement and carrying a light source
4: step of identifying anatomical sub-structures of the anatomical structure in the obtained images
6: step of carrying out three-dimensional modeling of the anatomical structure based on the obtained images
8: step of comparing the three-dimensional shape of the anatomical sub-structures of the obtained images with models of sub-structures stored in a database
11: image
11′: semantic segmentation
12: cornea
14: sclera
16: modeling

1-14. (canceled)

15. A method for modeling an anatomical structure of the human body in three dimensions that is computer-implemented, said method comprising the following steps:
obtaining a plurality of consecutive images of the anatomical structure using a device for capturing images that is in movement and that bears a light source, the light source being configured to illuminate the anatomical structure,
identifying anatomical sub-structures of the anatomical structure in the obtained images,
carrying out three-dimensional modeling of the anatomical structure based on the obtained images, and
comparing the three-dimensional shape of the anatomical sub-structures of the obtained images with models of anatomical sub-structures stored in a database,
wherein the step of carrying out three-dimensional modeling of the anatomical structure is based on the obtained images comprising predicting the depth of the anatomical structure and predicting the movement of the image-capturing device.

16. The modeling method according to claim 1, wherein the step of obtaining a plurality of consecutive images of the anatomical structure comprises recording a video followed by cutting this video into a plurality of consecutive images.

17. The modeling method according to claim 15, the modeling method being a self-supervised method.

18. The modeling method according to claim 17, comprising a step of feeding an artificial intelligence with sub-structure models stored in a database.

19. The modeling method according to claim 15, the modeling being carried out in real time.

20. The modeling method according to claim 15, wherein the step of performing a three-dimensional modeling of the anatomical structure from the images is a modeling of the identified anatomical sub-structures.

21. The modeling method according to claim 15, wherein the step of comparing the three-dimensional shape of the anatomical sub-structures of the obtained images with anatomical sub-structure models stored in a database comprises the use of the following loss functions: semantic reconstruction loss, sphere fitting loss, shape retention loss, and preferably photometric loss, structure similarity loss as well as depth smoothing.

22. The modeling method according to claim 15, the method being a three-dimensional eye modeling method.

23. The modeling method according to claim 22, wherein the anatomical sub-structures are the cornea and the sclera.

24. A computer program comprising instructions which, when the program is executed by a computer, cause the computer to implement the steps of the method according to claim 15.

25. A computer-readable recording medium comprising instructions which, when executed by a computer, cause the latter to implement the steps of the method according to claim 15.

26. A method for detecting a pathology resulting from the observation of a structure of the human body comprising:
a modeling method according to claim 15, and
a pathology diagnosis step based on the modeling performed.

27. A device for modeling an anatomical structure of the human body in three dimensions for carrying out a method according to claim 15, said device comprising:
a moving image-capturing device carrying a light source,
means for producing a three-dimensional model of the anatomical structure from the images obtained,
means for identifying anatomical sub-structures of the anatomical structure in the images obtained, and
means for comparing the three-dimensional shape of the anatomical sub-structures of the obtained images with the models of sub-structures stored in a database.

28. The modeling device according to claim 27, wherein the image-capturing device is formed by a camera configured to record video.
